(19) United States
(12) Patent Application Publication
(10) Pub. No.: US 2006/0227108 A1
(43) Pub. Date: Oct. 12, 2006

(54) Computer mouse for harsh environments and method of fabrication

(75) Inventors: Steven H. Meyer, Austin, TX (US); Joel A. East, Austin, TX (US); Kenneth A. Fuselier, Austin, TX (US)

Correspondence Address: HULSEY IP INTELLECTUAL PROPERTY LAWYERS, P.C., 1250 S. CAPITAL OF TEXAS HIGHWAY, BUILDING THREE, SUITE 160, AUSTIN, TX, 78746, US

(73) Assignee: iKey, Ltd.

(21) Appl. No.: 11/070,438

(22) Filed: Mar. 31, 2005

(51) Int. Cl. G09G 5/08

(52) U.S. Cl. 345/163

(57) ABSTRACT

A rugged computer mouse for use in a harsh liquid, chemical or gaseous environment, includes a pliable cover formed as a single unit that forms a generally impenetrable surface having a seal edge. The seal edge includes a trench. The surface has formed thereon at least one mouse control button region corresponding to a location of a pressure sensitive mouse control button. An ergonomically formed frame provides structural support and includes at least one pressure sensitive mouse button, which the mouse control button region covers. A mouse control circuit resides beneath the ergonomically formed frame and includes a mouse control button circuit that is responsive to pressure applied to the pressure sensitive mouse button. The mouse control circuit also includes a movement sensor and circuitry for relating the position of the computer mouse to the position of the graphical pointer. A base securely receives the mouse control circuit, the frame, and the pliable cover and comprises a ridge. The ridge inserts into the trough of the pliable cover and together with the pliable cover forms a generally impenetrable casing surrounding the frame, and the mouse control circuit.

### FIELD OF THE INVENTION

This invention pertains to computer systems and, more particularly, to a pointer device, commonly referred to as a mouse, which is used to control a visual pointer on a display of a computer system.

### BACKGROUND OF THE INVENTION

A computer system includes many components, such as the central processing unit (or processor); temporary memory for storing program instructions (like random access memory, or RAM); a permanent storage device (such as a hard disk); and a variety of user interface devices, such as a video display, a keyboard, and a pointing device which controls the movement of a graphical pointer on the display. The graphical pointer permits selecting certain areas on the screen, such as words in a text-only display or icons in a more complicated graphical user interface (GUI). The user selects an area by placing the graphical pointer over the area (i.e., moving the physical pointing device) and then clicking one or more buttons on the pointing device. The graphical pointer also assists performing other operations using the graphical pointer besides simple selection, such as “drag and drop” operations.

The pointing device, often referred to as a “mouse,” may come in a variety of physical embodiments. The most familiar design is a hand-held controller having a ball therein which extends partially through a hole in the bottom of the unit, so that the unit can be pushed along a flat surface to cause the ball to roll. Transducers within the unit (such as optical transducers) convert the motion of the ball to electrical signals which are transmitted to the processor or to a controller circuit connected to the processor, which, in turn, decodes those signals to determine how the graphical pointer on the display should be manipulated. Other physical embodiments of pointer devices include electrically sensitive pads, joysticks, and joystick-type actuators, a track ball, etc.

Because of the general acceptance and use of computers for countless operations, they appear in use for an increasing number of different work and entertainment environments. This includes harsh environments that may include dampness, wetness, damaging gases, heavy particulate matter and other types of environments. Within these environments, such pointing devices may be or become inoperative due to such environmental the environment constituents entering their mechanical, electrical, and electronic portions. Accordingly, there is a need for a mouse or pointing device that can survive such harsh environments.

Problems with the various different types of pointer devices presently available for harsh environments include the fact that users expect to use a device that is in form and function similar to a standard computer mouse. When new users attempt to operate pointing devices other than a standard mouse, inevitably inaccuracies and mistakes often occur in the control of the pointing operation. For example, known pointing devices for harsh environment take the form of an inductive joystick with no moving contacts. With such a device, the mouse cursor speed may be proportional to displacement of the joystick. Such devices attempt, but fail, to provide both speed and precision control until the user masters the operation of the new and different device.

With a normal computer mouse, there is no “learning curve” for an operator to climb in performing the pointing function. Accordingly, there is a need for a mouse computing device that is of a normal or generally accepted form and function for operation in harsh environments.

While computer device designers have attempted to produce a mouse pointing device for use in harsh environments, none has yet overcome the problems of protecting the mouse circuitry without presenting to the user a still different or awkward device. This is true, not only in the use of the mouse, but also in its manufacture.

Clearly, over the many years of computer mouse design and development, many evolutions of ergonomic improvements have arisen. Unfortunately, today's computer mouse for harsh environment include none of these ergonomic improvements.

Moreover, the few harsh environment or rugged computer mouse designs that do exist still fail to take into considerations the manufacturing improvements that have arisen over the years to produce such devices. For example, rugged computer mouse designs use a fully encapsulating cover that includes complicated manufacturing and design process such as requiring that a protective covering be molded to the mouse base. Such considerations add, unnecessarily, to the manufacturing costs of such devices.

Accordingly, there is a need for a rugged computer mouse that includes an ergonomic design for the benefit of the user. Still, there is the need for rugged computer mouse that, while overcoming the difficulties presently unsolved by the computer industry after so many years of computer use, may be manufactured with a minimal variation manufacturing processes presently employed by the computer industry.

### BRIEF SUMMARY OF THE INVENTION

It is, therefore, one object of the present invention to provide a hand-held pointer device for a computer system capable of operating in harsh environments.

It is another object of the present invention to provide such a pointer device that is of a normal or generally accepted form and function for operation in harsh environments.

It is yet another object of the present invention to provide a rugged computer mouse that includes an ergonomic design.

Still another object of the present invention is to provide a rugged computer mouse that may be manufactured with a minimal variation in the manufacturing processes presently employed by the computer industry.

The foregoing objects are achieved in a hand-held mouse generally comprising a computer mouse for selecting a visual object indicated by a location of a graphical pointer on a computer display. The computer mouse includes generally a pliable cover formed as a single unit that forms a generally impenetrable surface having a seal edge. The seal edge includes a trench. The surface has formed thereon at least one mouse control button region corresponding to a location of a pressure sensitive mouse control button. An ergonomically formed frame provides structural support and includes at least one pressure sensitive mouse button, which the mouse control button region covers. A mouse control circuit resides beneath the ergonomically formed frame and includes a mouse control button circuit that is responsive to pressure applied to the pressure sensitive mouse button. The mouse control circuit also includes a movement sensor and circuitry for relating the position of the computer mouse to the position of the graphical pointer. A base securely receives the mouse control circuit, the frame, and the pliable cover and comprises a ridge. The ridge inserts into the trough of the pliable cover and together with the pliable cover forms a generally impenetrable casing surrounding the frame, and the mouse control circuit.

The present invention may further provide an opening within the pliable cover for receiving a communications cable connecting between the mouse control circuit and an associated computer. The opening and communications cable associate so as to form a generally impenetrable seal protecting the mouse control circuit from a harsh environment. Moreover, the base may include transparent lens for communicating optical signals from the movement sensor and circuitry. The lens is formed so as to minimize or substantially eliminate the potential buildup of residue from the harsh environment.

The present invention, therefore, provides a rugged computer mouse for use with a computer in a waterproof and sealed structure that is chemical resistant. Moreover, the present invention provides these advantages without the need for a specially-designed rubber molding that occurs only through the use of an additional complicated manufacturing process. The rugged computer mouse of the present embodiment may be washed down with water or sterilized with disinfectant without damage and provides an attractive pointing device for use with a computer in harsh industrial environments, hospital and health care institutions, laboratory situations and food service and manufacturing applications.

The above as well as additional objectives, features, and the advantages of the present invention will become apparent in the following detailed written description.

### BRIEF DESCRIPTIONS OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 illustrates a computer system and related peripherals that may operate with the rugged computer mouse of the present embodiment;

FIG. 2 shows a top view of the rugged computer mouse of the present embodiment;

FIG. 3 shows a bottom view of the rugged computer mouse of the present embodiment;

FIG. 4 presents an expanded view of the rugged computer mouse of the present embodiment;

FIG. 5 shows a top view of the rugged computer mouse cover of the present embodiment;

FIG. 6 shows a bottom view of the rugged computer mouse cover of the present embodiment;

FIG. 7 shows a plan view of the rugged computer mouse cover of the present embodiment;

FIG. 8 shows a plan view of the rugged computer mouse cover of the present embodiment as viewed from cross-section A-A;

FIG. 9 shows a plan view of the rugged computer mouse cover of the present embodiment as viewed from cross-section B-B;

FIG. 10 shows a plan view of the rugged computer mouse cover of the present embodiment as viewed from cross-section C-C;

FIG. 11 shows a top view of the rugged computer mouse cover of the present embodiment;

FIG. 12 shows a bottom view of the rugged computer mouse cover of the present embodiment;

FIG. 13 shows a plan view of the rugged computer mouse frame of the present embodiment;

FIG. 14 shows a plan view of the rugged computer mouse frame of the present embodiment as viewed from cross-section A-A;

FIG. 15 shows a plan view of the rugged computer mouse frame of the present embodiment as viewed from cross-section B-B;

FIG. 16 shows a plan view of the rugged computer mouse frame of the present embodiment as viewed from cross-section C-C;

FIG. 17 shows a top view of the rugged computer mouse circuit board of the present embodiment;

FIG. 18 shows a bottom view of the rugged computer mouse circuit board of the present embodiment;

FIG. 19 shows a top view of the rugged computer mouse base of the present embodiment;

FIG. 20 shows a bottom view of the rugged computer mouse base of the present embodiment; and

FIG. 21 displays an elastomeric keyboard to illustrate another device that may be operated in conjunction with the rugged computer mouse of the present embodiment.

### DETAILED DESCRIPTION OF ILLUSTRATIVE EMBODIMENTS

Although described with particular reference to a personal computer, the claimed subject matter can be implemented in any information technology system in which it is necessary or desirable to achieve rapid and efficient use of memory resources during processing operations.

Those with skill in the computing arts will recognize that the disclosed embodiments have relevance to a wide variety of computing environments in addition to those specific examples described below. In addition, the methods of the disclosed invention can be implemented in software, hardware, or a combination of software and hardware. The hardware portion may be implemented using specialized logic; the software portion can be stored in a memory and executed by a suitable instruction execution system such as a microprocessor, personal computer or mainframe.

All references, including publications, patent applications, and patents, cited herein are hereby incorporated by reference to the same extent as if each reference were individually and specifically indicated to be incorporated by reference and were set forth in its entirety herein.

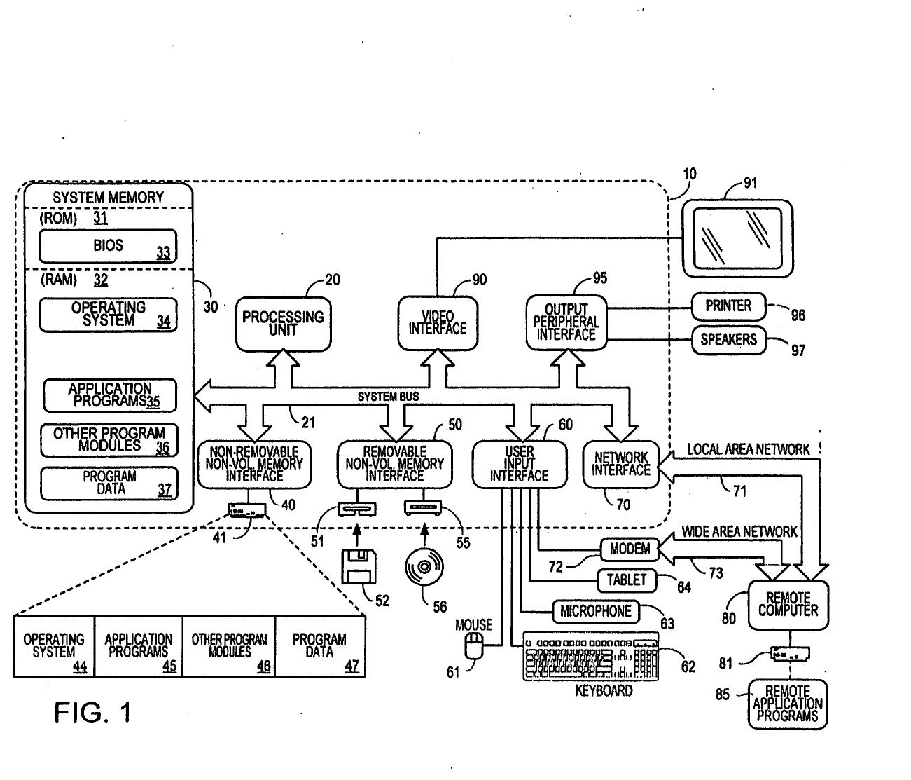

FIG. 1 illustrates an example of a suitable computing system 10 on which the invention may be implemented. The computing system 10 is only one example of a suitable computing environment and is not intended to suggest any limitation as to the scope of use or functionality of the invention. Neither should the computing 10 be interpreted as having any dependency or requirement relating to any one or combination of components illustrated in the exemplary operating computing system 10.

With reference to FIG. 1, an exemplary system within a computing environment for implementing the invention includes a general purpose computing device in the form of a computing system 10. Components of the computing system 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures.

Computing system 10 typically includes a variety of computer readable media. Computer readable media can be any available media that can be accessed by the computing system 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 10.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computing system 10, such as during start-up, is typically stored in ROM 31. RAM 132 typically contains data and/or program modules that are immediately accessible to and/or presently being operated on by processing unit 20. By way of example, and not limitation, FIG. 1 illustrates operating system 34, application programs 35, other program modules 136 and program data 37.

Computing system 10 may also include other removable/non-removable, volatile/nonvolatile computer storage media. By way of example only, FIG. 1 illustrates a hard disk drive 41 that reads from or writes to non-removable, nonvolatile magnetic media, a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive-55 are typically connected to the system bus 21 by a removable memory interface, such as interface 50.

The drives and their associated computer storage media, discussed above and illustrated in FIG. 1, provide storage of computer readable instructions, data structures, program modules and other data for the computing system 10. In FIG. 1, for example, hard disk drive 41 is illustrated as storing operating system 44, application programs 45, other program modules 46 and program data 47. Note that these components can either be the same as or different from operating system 34, application programs 35, other program modules 36, and program data 37. Operating system 44, application programs 45, other program modules 46, and program data 47 are given different numbers hereto illustrate that, at a minimum, they are different copies.

A user may enter commands and information into the computing system 10 through input devices such as a tablet, or electronic digitizer, 64, a microphone 63, a keyboard 62 and pointing device 61, commonly referred to as a mouse, trackball or touch pad. In particular, the present embodiment provides a novel rugged computer mouse 110, as described in detail below, that operates in an Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB).

A monitor 91 or other type of display device is also connected to the system bus 21 via an interface, such as a video interface 90. The monitor 91 may also be integrated with a touch-screen panel or the like. Note that the monitor and/or touch screen panel can be physically coupled to a housing in which the computing system 10 is incorporated, such as in a tablet-type personal computer. In addition, computers such as the computing system 10 may also include other peripheral output devices such as speakers 97 and printer 96, which may be connected through an output peripheral interface 94 or the like.

Computing system 10 may operate in a networked environment using logical connections to one or more remote computers, such as a remote computing system 80. The remote computing system 80 may be a personal computer, a server, a router, a network PC, a peer device or other common network node, and typically includes many or all of the elements described above relative to the computing system 10, although only a memory storage device 81 has been illustrated in FIG. 1. The logical connections depicted in FIG. 1 include a local area network (LAN) 71 and a wide area network (WAN) 73, but may also include other networks. Such networking environments are commonplace in offices, enterprise-wide computer networks, intranets and the Internet. For example, in the present embodiment, the computer system 10 may comprise the source machine from which data is being migrated, and the remote computing system 80 may comprise the destination machine. Note however that source and destination machines need not be connected by a network or any other means, but instead, data may be migrated via any media capable of being written by the source platform and read by the destination platform or platforms.

The computer system 10 of FIG. 1 may be in a harsh environment or may require use of hand-held devices, such as that of the present embodiment to operate in a harsh environment. As such, the following description explains the various features of the present embodiment of a rugged computer mouse that achieves these purposes.

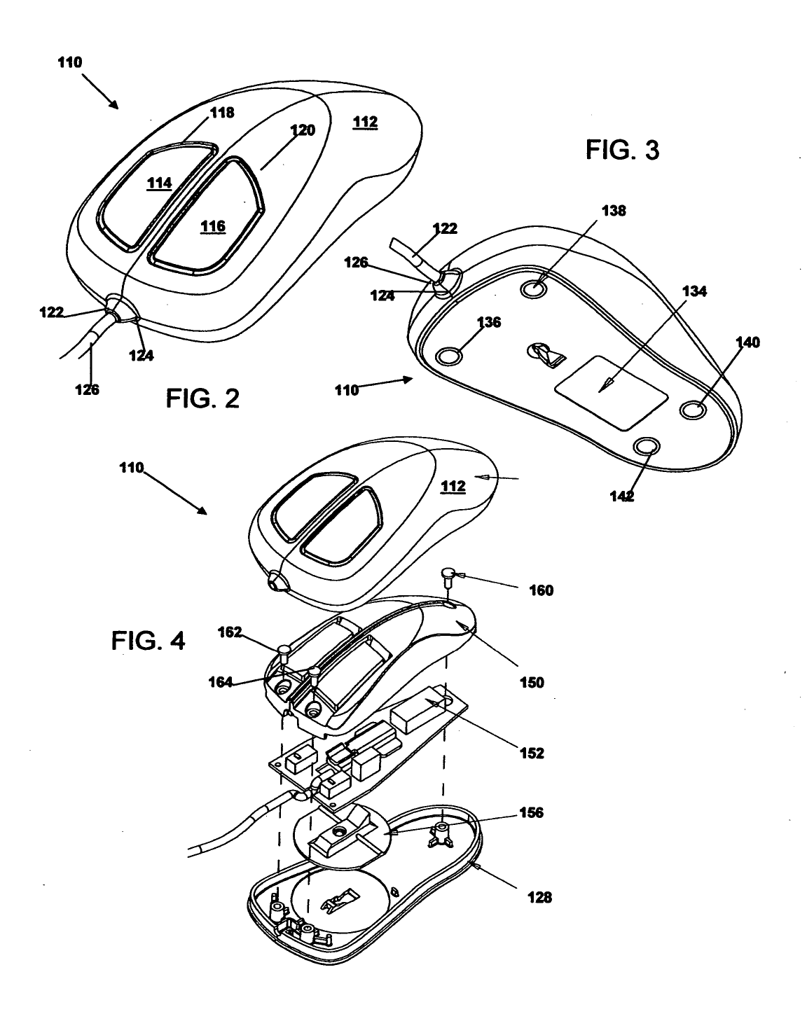

FIGS. 2 and 3, respectively, show a top view and bottom view of computer mouse 110. Referring to FIG. 2, computer mouse 110 includes cover 112 having an ergonomically beneficial shape for a user to hold. Cover 112 includes mouse control button regions 114 and 116 that are positioned to allow a user to control computer mouse 110. Surrounding mouse control button regions 114 and 116 are moat regions 118 and 120, respectively. Moat regions 118 and 120 are pliable in response to pressure applied to mouse control button regions 114 and 116, but maintain a waterproof, gas proof, and generally impenetrable separation between mouse control button regions 114 and 116 and the remaining portion of cover 112. Cable 122 connects circuitry within computer mouse 112 to an associated computer system. Collar 124 surrounds cable 122 in a waterproof, gas proof, and particulate proof junction 126. Junction 126 occurs by forming collar 124 to be measurably smaller than the cable 122 outside diameter.

FIG. 3 shows a bottom view of the rugged computer mouse of the present embodiment. In FIG. 4, computer mouse 110 positions cover 112 around base 128 using a generally impenetrable outer seal 130, which is described more completely herein. Base 128 further includes optical sensor lens region 132 and label space 134. To facilitate computer mouse 110 movements over a flat surface, such as a table, desk, or counter top, Teflon feet 136, 138, 140, and 142 are positioned along various points on base 128 so as balance the applied user hand weight during use.

FIG. 4 shows an exploded view of computer mouse 110 of the present embodiment with cover 112 positioned over frame 150. Frame 150 provides structural support for the user holding computer mouse 110 and establishes a protective housing around circuit board 152. Circuit board 152 connects to an associated computer system via cable 122. Circuit board 152 covers optical lens 156, which rests in lens recess 158. Holding frame 150, circuit board 152, and optical lens 156 to base 128 are pins or screws 160, 162, and 164.

The rugged computer mouse 110, thus, includes mouse control button regions 114 and 116, and an optical sensor 132. When computer mouse 110 is pushed along a relatively flat surface, the computer mouse 110 movements are sensed and appropriate signals are generated and sent to the computer system via cable 122 (transmission can also be wireless, e.g., radio wave or infrared). The signals are typically sensed by an input/output (I/O) controller that is connected to the computer's central processing unit (CPU). The CPU interprets the signals and sends appropriate data to a display adapter, which then causes “movement” of the graphical pointer on the display.

Mouse movement, measured in units called “mickies,” is a constant of the mouse itself. A certain mouse movement distance always results in the same number of mickies being reported to the host system. Software commonly allows the user to adjust the sensitivity (i.e., speed) of the graphical pointer, such that it may be slowed down to allow finer movements or sped up to move the pointer more quickly across the display screen, by programming different pointer movement rates for a certain number of mickies. A similar software adjustment can provide for “acceleration” of the graphical pointer, i.e., moving the graphical pointer even more quickly, based on the length of time that the mouse is being moved along a given direction.

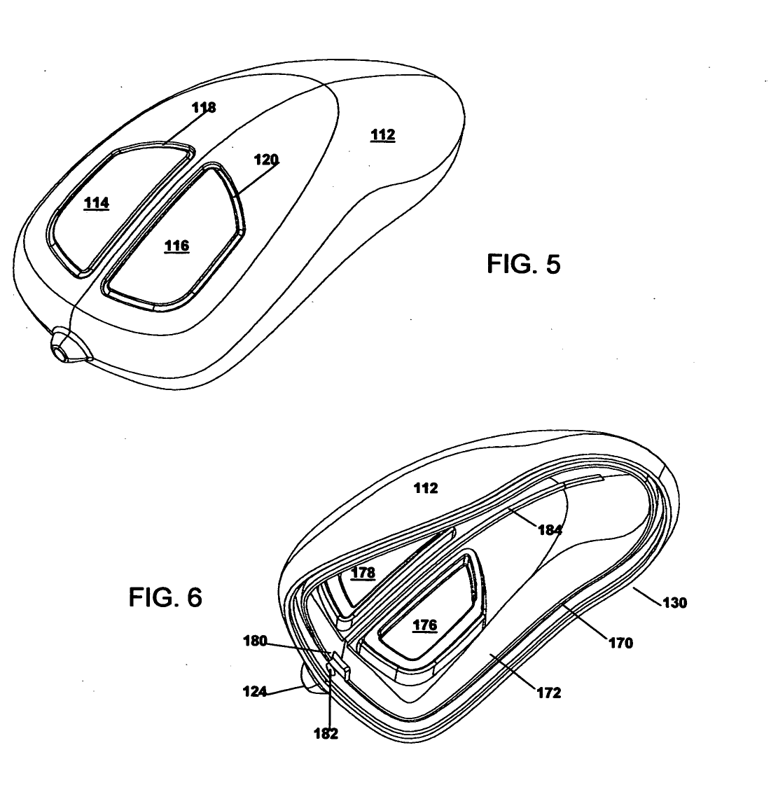

FIGS. 5 and 6 show, respectively, top and bottom views of the rugged computer mouse cover 112 of the present embodiment. Mouse cover 112 includes outer seal 130, which surrounds trough 170, which further surrounds inner seal 172. Inner seal 172 adjoins inner wall 174. Inner wall 174 adjoins pads 176 and 178 on the underside of mouse control button regions 114 and 116, respectively, through moat regions 118 and 120. Pads 176 and 178 provide a rubber extension of mouse cover 112 to buttons (described below) of frame 150. Inner wall 174 of mouse cover 112 further includes clearance region 180 for the passage of cable 122 through channel 182 of collar 24. For assuring the position of mouse cover 112 over frame 150, alignment rib recess 184 extends along inner wall 174.

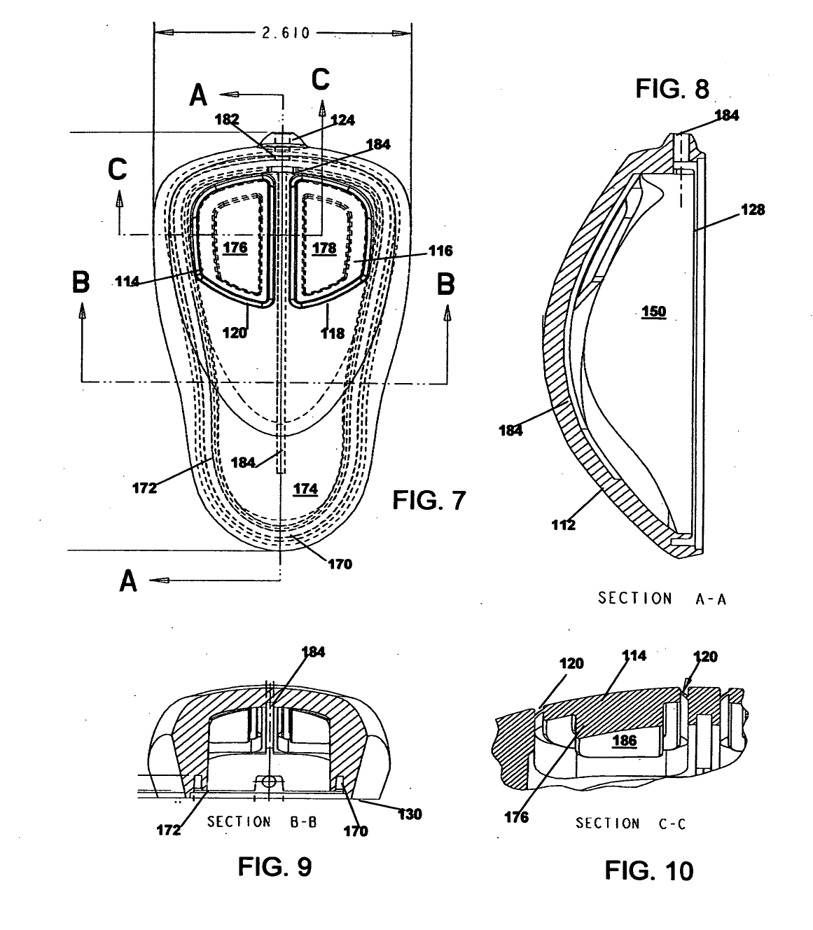

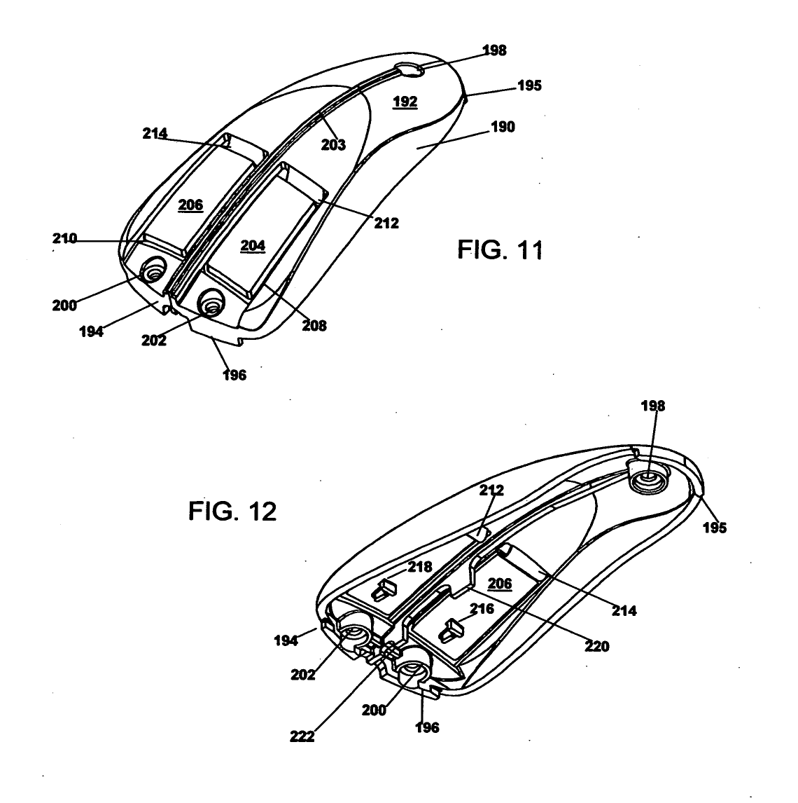

FIGS. 7, 8, 9, and 10 show plan views of the rugged computer mouse cover of the present embodiment as viewed from cross-sections A-A, B-B, and C-C, respectively. From the top-down perspective of FIG. 7, the dimensions of the present embodiment of mouse cover 112 may be understood. These dimensions, however, may vary depending on the implementation and other factors. Thus, mouse cover 112 forms a symmetrically shaped covering including pliable mouse cover button regions 114 and 116 that form a smooth contour with cover 112 and which are surrounded by moat regions 118 and 120 and form an integral structure with pads 176 and 178. Alignment rib recess 184 is in line with channel 182 of collar 124. The coordination of outer seal 130, trough 170, and inner seal 172 present a unified structure that may be placed over frame 150 in establishing a waterproof, and gas and particulate impenetrable encasement. Cross-sectional views of FIGS. 8, 9, and 10 depict the relative positioning of mouse cover 112 in association with frame 150 and base 128.

FIGS. 11 and 12 show, respectively, top and bottom views of the rugged computer mouse frame 150 of the present embodiment. Referring primarily to FIG. 12, frame 150 includes frame sidewall 190 and frame upper wall 192, which provide a rigged polymer structure around to place a hand in controlling the position of computer mouse 110. Base connectors 194, 195, and 196 provide a connecting structure for the placement of frame 150 in a secure fit within base 128. Pin collars 198, 200, and 202 receive, respectively, pins 160, 162, and 164 (FIG. 5). Because of its form, centering fin 203 fits within alignment rib recess 184 of cover 112 to help maintain a firm fit and positioning of cover 112 over frame 150. Mouse control buttons 204 and 206 reside within button apertures 208 and 210. Flexible cantilever hinges 212 and 214 support and allow vertical movement of mouse control buttons 204 and 206. In particular, FIG. 11 shows how the present embodiment of pad 176 contacts and may control the movement of frame button 186, as described with FIGS. 11 through 16 below.

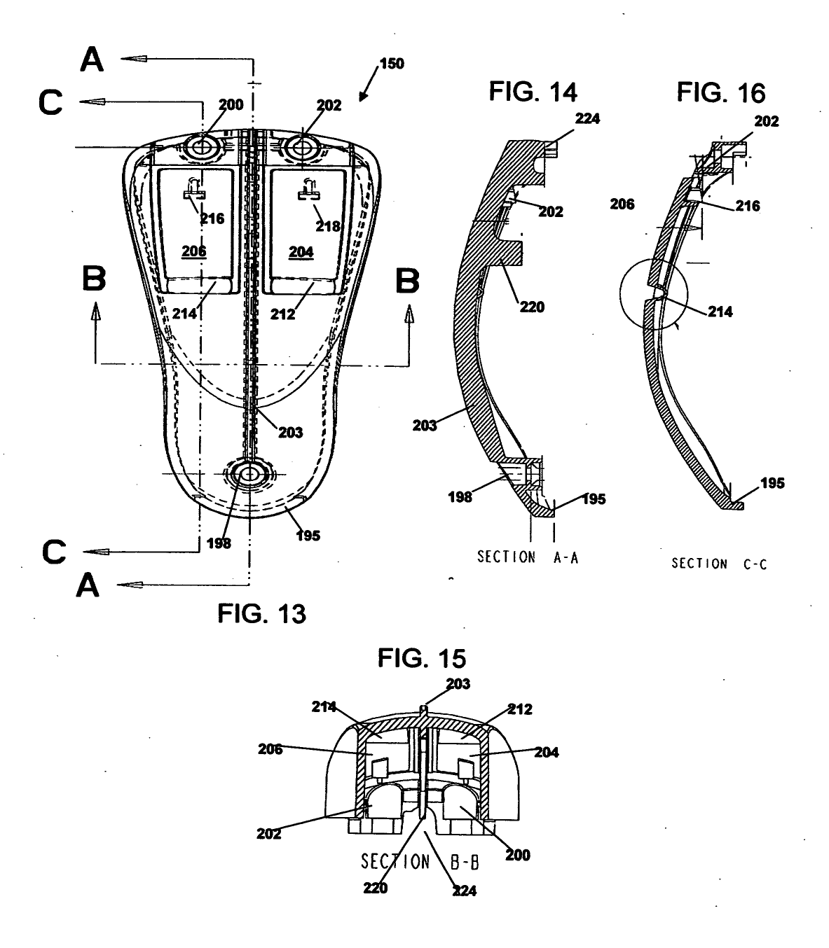

FIG. 13 further shows switch actuators 216 and 218 on the underside of mouse control buttons 204 and 206. Positioning fins 220 and 222 extend downward from the underside of frame 150 for ultimately contacting associated structures on circuit board 152, which when in contact further establish position structural support for frame 150. Cable aperture 124 provides a passageway for by which cable 122 may pass from collar 124 to communications and control circuitry of circuit board 152.

FIG. 14 shows a plan view of the rugged computer mouse cover of the present embodiment. FIGS. 14, 14 and 15 show plan views of the rugged computer mouse frame 150 of the present embodiment as viewed from cross-sections A-A, B-B, and C-C, respectively. From the top-down perspective of FIG. 14, the dimensions of the present embodiment of mouse frame 150 may be understood. These dimensions, however, may vary depending on the implementation and other factors. Thus, frame 150 forms a symmetrically shaped structural member coupled with control functions of mouse control buttons 204 and 206. Cross-sectional views of FIGS. 14, 15, and 16 depict the relative dimensions and orientation of positioning fins 220 and 222, as well as the relative dimensions of pin collars 198 and 202, base connector 195, and cable aperture 124. In particular, FIG. 15 shows how the present embodiment of switch actuators 216 and 218 may extend downward to contact and control the actuation of control switches on circuit board 152 (FIG. 18). In addition, FIG. 16 provides a view of the structure of cantilever hinge 214, which may be formed as a flexible and integral part of frame 150.

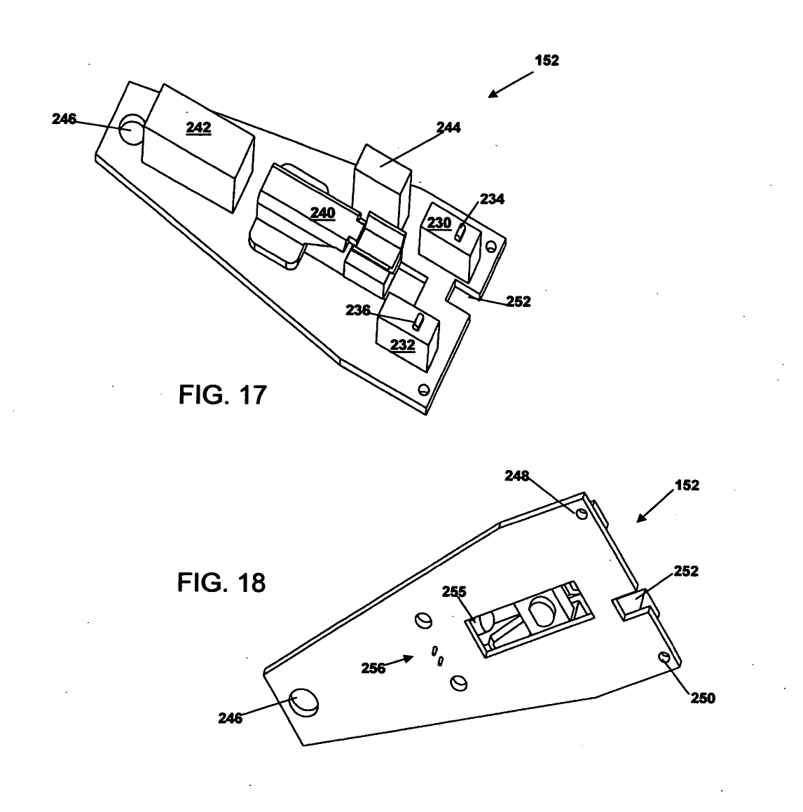

FIGS. 17 and 18 show, respectively, top and bottom views of the rugged computer mouse circuit board 152 of the present embodiment. Printed circuit board 152 includes mouse control switches 230 and 232, which, in the embodiment shown, mouse control switch contacts 234 and 236 interface with switch actuators 216 and 218 of frame 150. Optical transmission circuitry 240 provides for sensing and transmission of optical position measuring signals. Controller 242 supports the various position and graphical user interface command and control functions for proper computer mouse 110 operation. Collar positioning aperture 246 is located to cooperate with pin collar 198 of frame 150. Pin positioning apertures 248 and 250 receive positioning pins 270 and 272 of base 128 (FIG. 20). Cable passageway 252 allows cable 122 to connect to communications and control circuitry 242 and cable connector 244 for communication with an associated computer system. In FIG. 18, optical transmission component 254 includes LED 255 and provides for the communication of optical signals from communications and control circuitry 242. Positioning recesses 256 provide a positive and firm association of circuit board 152 with base 128.

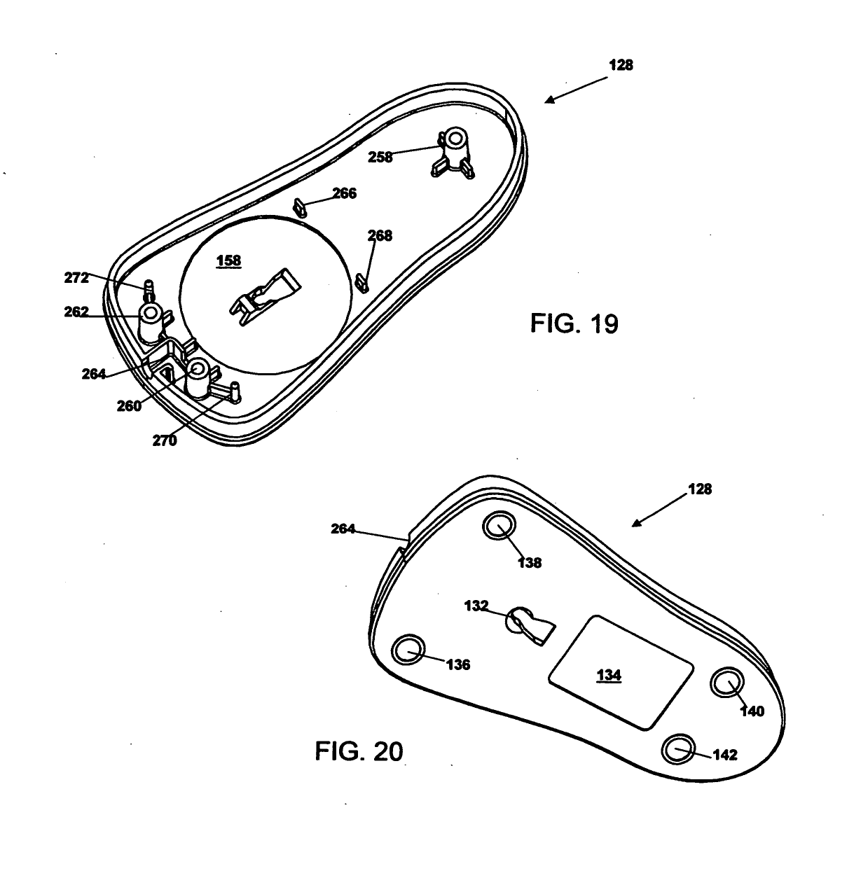

FIGS. 19 and 20 show, respectively, top and bottom views of the rugged computer mouse base 128 of the present embodiment. Base 128 associates with lens 158 to (1) form a generally impenetrable enclosure in cooperation with cover 112; (2) support and rigidly position frame 150, (3) support and rigidly position circuit board 152, and (4) communicate optical position signals between optical transmission circuitry 240 and surfaces over which computer mouse 110 moves.

To achieve these functions, base 128 includes pin receptor 258, 260, and 262 that align with corresponding pin collars 198, 200, and 202 for receiving associated pins 160, 162, and 164. Cable harness 264 receives and cooperates with collar 124 for securing cable 122 in place and preventing tension arising from the movement of computer mouse 110 and associated with the pulling of cable 122 from affecting the electrical connection between communication and control electronics 242 and the associate computer system. Circuit board alignment pins 266, 268, 270, and 272 correspond to positioning recesses 256 and pin position apertures 248 and 250 of circuit board 152 for positioning circuit board 152. Support rib 157 surround the inner portion of base 154 to accommodate the outer surface of frame 150 and form a coupling with trough 170 of cover 112.

Lens recess 158 receives and makes possible a sealed interface with optical lens 156 (FIG. 5). Lens aperture 274 cooperates with lens 156 for providing a region of optical communication that prevents or substantially eliminates for collection of any residue of dried liquids, particulates, dust, or other contaminants that may arise from operation of computer mouse 110 in a harsh environment.

Cover 112 is preferably formed of a silicone rubber and forms a liquid and gas impenetrable seal around frame 150. Lens 156 permits the transmission of laser or other light to reflective surface for indicating movement of computer mouse 110 over a surface. Outer seal 130 includes a silicon rubber webbing form that not only forms a waterproof seal, but also provides a mechanical snap or friction fit for cover 112. In addition, the mating between Lens 156 is formed, in the present embodiment, to be of a circular shape. For providing the desired impenetrable seal, a double-sided adhesive tape bonds lens 156 to lens recess 158. Lens region 132 is formed to permit cleaning by way of flushing or other means. This prevents the buildup of bacteria or residues that would, if allowed to accumulate, adversely affect computer mouse 110 operation.

Trough 170 possesses the attractive aspect of having a depth sufficient to maximize the surface area of silicon adhesive during the coupling of base 154 with cover 112. That is, for the present embodiment, trough 170 is a small deeper and wider than the depth of support rib 257 on base 128.

The present embodiment may be used in association with an elastomeric keyboard that fits within a standard notebook computer using a novel keyboard switch matrix interconnect structure together with a back-lighting architecture for illuminating the individual keys of the elastomeric keyboard. Such a keyboard is described and claimed in U.S. Pat. No. 6,057,517 issued on May 2, 2000 to inventor Steven H. Meyer, and assigned to Texas Industrial Peripherals, now known as iKey, Ltd., the common owner of this patent application (hereinafter the “'517 Patent”).

The '517 Patent, which is here expressly incorporated by reference, describes and claims an elastomeric keyboard incorporating a novel interconnect and back-lighting architecture of the present invention includes a printed circuit board and a novel multi-layer membrane switch matrix interconnect structure. The printed circuit board contains a control circuit for powering and controlling the back-lighting of the elastomeric keyboard. The electrical components which make up the control circuit are mounted on a top side of the printed circuit board. The multi-layer switch matrix interconnect structure contains multiple holes arranged to coincide with the components of said control circuit. The multi-layer switch matrix interconnect structure also contains a number of electrical connectors, a number of conductive contacts, and a number of electrical nets for electrically connecting the conductive contacts to each other and to the electrical connectors.

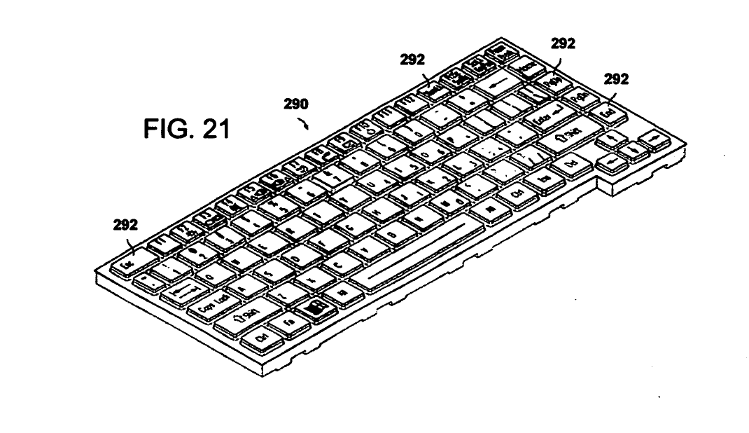

To further illustrate some features of the reference keyboard FIG. 21 shows an elastomeric keypad 1 290 according to the present invention. The elastomeric keypad is comprised of a plurality of keys 292. The elastomeric keypad 290 can be a standard sized notebook computer keypad. The elastomeric keypad 290 begins as a clear elastomeric keypad made from a standard mold. The clear elastomeric keypad can be painted white and then painted black. Finally, the black paint may be etched off to reveal the white paint on each of the keys 292 so that a particular character is depicted. The features here described and relating to elastomeric keypad 290 are for illustration. other aspects of elastomeric keypad 290 as described in the '517 Patent are, likewise, incorporated herein.

While various embodiments of the present embodiment have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present embodiment should not be limited by any of the above-described exemplary embodiments, but should be defined only in accordance with the following claims and their equivalents.

What is claimed is:

1. A hand-held device for transmitting signals used to control a graphical pointer on a display of a computer system, comprising:
a pliable cover formed as a single unit that forms a generally impenetrable surface having a seal edge, said seal edge comprising a trench, said surface comprising at least one mouse control button region formed integrally from said pliable cover and corresponding to a location of a pressure sensitive mouse control button;
a frame for providing structural support and comprising at least one pressure sensitive mouse button, said mouse control button region covering said mouse button;
a mouse control circuit beneath said frame and comprising a mouse control button circuit, said mouse control button circuit responsive to pressure applied to the pressure sensitive mouse button and further comprising a movement sensor and circuitry for relating the position of the computer mouse to the position of the graphical pointer; and
a base for securely receiving said mouse control circuit, said frame, and said pliable cover, said base comprising a sealing rib for inserting into said trough and together with said pliable cover forming a generally impenetrable casing surrounding said frame and said mouse control circuit.

2. The hand-held device of claim 1, further comprising an optical transmission lens for communicating optical position measurement signals from an optical position sensing circuit for determining the position of said hand-held device, said optical transmission lens forming a generally impenetrable seal between said optical position sensing circuit and said harsh environment.

3. The hand-held device of claim 1, further comprising a moat region surrounding said mouse control button region, said moat region forming a pliable generally impenetrable seal and formed integrally with said pliable cover.

4. The hand-held device of claim 1, further comprising a cantilever hinge for hingedly and flexibly supporting said mouse control button, said cantilever hinge formed integrally from said frame.

5. The hand-held device of claim 1, further comprising a collar formed integrally from said pliable cover, said collar formed to receive in a generally impenetrable seal a cable from an associated computer system for communicating with said mouse control circuit.

6. The hand-held device of claim 1, further comprising an alignment rib formed integrally from said frame and an alignment rib recess formed integrally within said pliable cover, said alignment rib and said alignment rib recess for engaging to position said pliable cover at a predetermined position relative to said frame.

7. A computer system for operating in a harsh environment, and including a hand-held device for transmitting signals used to control a graphical pointer on a display of said computer system, comprising:
a computer processor for communicating and displaying graphical user interface control commands and information;
a computer display operating in association with said computer processer for displaying a plurality of graphical user interface operations; and
a hand-held device for operating in a harsh environment in association with said computer processor and said computer display, said hand-held device comprising:
a pliable cover formed as a single unit that forms a generally impenetrable surface having a seal edge, said seal edge comprising a trench, said surface comprising at least one mouse control button region formed integrally from said pliable cover and corresponding to a location of a pressure sensitive mouse control button;
a frame for providing structural support and comprising at least one pressure sensitive mouse button, said mouse control button region covering said mouse button;
a mouse control circuit beneath said frame and comprising a mouse control button circuit, said mouse control button circuit responsive to pressure applied to the pressure sensitive mouse button and further comprising a movement sensor and circuitry for relating the position of the computer mouse to the position of the graphical pointer; and
a base for securely receiving said mouse control circuit, said frame, and said pliable cover, said base comprising a sealing rib for inserting into said trough and together with said pliable cover forming a generally impenetrable casing surrounding said frame and said mouse control circuit.

8. The computer system of claim 7, wherein said hand-held device further comprises an optical transmission lens for communicating optical position measurement signals from an optical position sensing circuit for determining the position of said hand-held device, said optical transmission lens forming a generally impenetrable seal between said optical position sensing circuit and said harsh environment.

9. The computer system of claim 7, wherein said hand-held device further comprises an a moat region surrounding said mouse control button region, said moat region forming a pliable generally impenetrable seal and formed integrally with said pliable cover.

10. The computer system of claim 7, wherein said hand-held device further comprises a cantilever hinge for hingedly and flexibly supporting said mouse control button, said cantilever hinge formed integrally from said frame.

11. The computer system of claim 7, wherein said hand-held device further comprises a collar formed integrally from said pliable cover, said collar formed to receive in a generally impenetrable seal a cable from an associated computer system for communicating with said mouse control circuit.

12. The computer system of claim 7, wherein said hand-held device further comprises an alignment rib formed integrally from said frame and an alignment rib recess formed integrally within said pliable cover, said alignment rib and said alignment rib recess for engaging to position said pliable cover at a predetermined position relative to said frame.

13. The computer system of claim 7, further comprising an elastomeric keyboard for operation in association with said hand-held device.

14. A method of forming a hand-held device for transmitting signals used to control a graphical pointer on a display of a computer system, comprising the steps of:
forming a pliable cover as a single unit and generally impenetrable surface having a seal edge, said seal edge comprising a trench, said surface comprising at least one mouse control button region formed integrally from said pliable cover and corresponding to a location of a pressure sensitive mouse control button;
forming a frame for providing structural support and comprising at least one pressure sensitive mouse button, said mouse control button region covering said mouse button;
forming a mouse control circuit beneath said frame and comprising a mouse control button circuit, said mouse control button circuit responsive to pressure applied to the pressure sensitive mouse button and further comprising a movement sensor and circuitry for relating the position of the computer mouse to the position of the graphical pointer; and
forming a base for securely receiving said mouse control circuit, said frame, and said pliable cover, said base comprising a sealing rib for inserting into said trough and together with said pliable cover forming a generally impenetrable casing surrounding said frame and said mouse control circuit.

15. The method of claim 14, further comprising the step of forming an optical transmission lens for communicating optical position measurement signals from an optical position sensing circuit for determining the position of said hand-held device, said optical transmission lens forming a generally impenetrable seal between said optical position sensing circuit and said harsh environment.

16. The method of claim 14, further comprising the step of forming a moat region surrounding said mouse control button region, said moat region forming a pliable generally impenetrable seal and formed integrally with said pliable cover.

17. The method of claim 14, further comprising the step of forming a cantilever hinge for hingedly and flexibly supporting said mouse control button, said cantilever hinge formed integrally from said frame.

18. The method of claim 14, further comprising the step of forming a collar formed integrally from said pliable cover, said collar formed to receive in a generally impenetrable seal a cable from an associated computer system for communicating with said mouse control circuit.

19. The method of claim 14, further comprising the step of forming an alignment rib integrally from said frame and an alignment rib recess integrally within said pliable cover, said alignment rib and said alignment rib recess for engaging to position said pliable cover at a predetermined position relative to said frame.

20. The method of claim 14, further comprising the step of forming an an elastomeric keyboard for operation in association with said hand-held device.
